(19) United States
(12) Patent Application Publication
(10) Pub. No.: US 2015/0040475 A1
(43) Pub. Date: Feb. 12, 2015

(54) Container For Storing And Planting Seeds, Bulbs Or Tubers

(71) Applicant: Centre De Recherche Public - Gabriel Lippmann, Belvaux (LU)

(72) Inventors: Thomas Schleeh, Schweich (DE); Jean-Francois Hausman, Musson (BE)

(73) Assignee: Centre De Recherche Public-Gabriel Lippmann, Belvaux (LU)

(21) Appl. No.: 14/384,321

(22) PCT Filed: Mar. 5, 2013
(86) PCT No.: PCT/EP2013/054397

§ 371 Date: Sep. 10, 2014

(30) Foreign Application Priority Data
Mar. 16, 2012 (LU) 91959

(51) Int. Cl. A01G 9/10

(52) U.S. Cl. CPC A01G 9/10
USPC 47/66.7; 47/65.5

(57) ABSTRACT

The present invention is directed to a container for storing and planting seeds, bulbs or tubers, the container comprising a housing made of a non-water soluble material, wherein the housing comprises a first compartment for receiving a seed, bulb or tuber, wherein the first compartment is essentially free of water, and a second compartment arranged below the first compartment, for receiving nutrients promoting growth of the seed, bulb or tuber. Still in accordance with the present invention, the container comprises a separation layer between the first and the second compartments, wherein the housing has a rounded shape at its bottom and the container has a center of gravity arranged such that the container is adapted to erect itself when it is deposited on a supporting surface in a tilted manner.

### CROSS-REFERENCE TO RELATED APPLICATIONS

The present invention is the US national stage under 35 U.S.C. §371 of International Application No. PCT/EP2013/054397, which was filed on Mar. 5, 2013, and which claims the priority of application LU 91959 filed on Mar. 16, 2012 the content of which (text, drawings and claims) are incorporated here by reference in its entirety.

### FIELD

The present invention is directed to a planting container or box, in particular to a container for storing and planting seeds, bulbs, or tubers.

### BACKGROUND

Many systems and methods for planting seeds or seedlings are known in the prior art.

Normally plants are raised in a nursery garden or in a greenhouse up to a desired size and are then replanted to a habitat. However, until the plantlings have reached that desired size they usually require constant care. In particular, they must be provided with soil and water. Further, such plantlings can occupy a considerable space, which is provided in many cases in a building in order to protect the plantlings from chilling or freezing, drought, strong winds or too intensive sun light.

Another disadvantage is that the sensitive plantlets must be handled with care on their way from a nursery garden to their destination. Depending on the time needed for transport of the plantlets to their final habitat, they require water or sun light to survive. After arrival at the planting position, usually a hole has to be dug and an additional amount of water is required for ensuring growth of the plant at that position. Although the amount of water required might be small, it has to be ensured that water is applied exactly at the position of the plantlet.

Further issues arise when planting large amounts of plants. In case of forestation, hundreds or even thousands of plants or trees have to be provided. Further, the areas for forestation are often difficult to access. Thus, also for this reason the costs for planting can become unsatisfactorily high. Further problems can arise if the ground envisaged for planting is very hard, stony, dry or comprises already a large amount of roots.

U.S. Pat. No. 3,273,284 discloses a planting container for planting seedlings by way of an air-borne drop. The planting container comprises a seedling provided in a wire mesh provided in an elongate receptacle made of a material which disintegrates upon exposure to water. A water-filled bladder is provided below the wire mesh containing the seedling, which is pierced by a needle upon impact of the planting container on the ground. The water spilled from the pierced bladder degrades immediately the receptacle and allows the seedling to enroot in the surrounding soil.

However, that planting container can especially be ineffective in case of very hard, stony frozen or already enrooted ground since it cannot penetrate into such a surface. Another disadvantage of the mentioned disclosure consists in the fact that the plant gets into contact with the environment directly after its drop. This can result in death of the plantling if it is dropped in a hostile, e.g. polluted area. Further, the known planting container is difficult and expensive to produce and assemble. In particular, the seedling has to be raised first and is then included in the container, thus complicating also the transport of that device. Convenient and cheap long-term storage of the container is not possible since the plantlet would die without sufficient water supply or exposure to sunlight.

Another general issue consists in creating new habitats in barren, extremely dry or polluted areas. In such cases experience has shown that plantlings or seedlings often fade after some time of growth. Reasons might be a lack of water or nutrients or an amount of hazardous substances unbearable for the young plant before having reached a certain crucial size.

The technical problem of the present invention is to provide an advanced, preferably compact, planting container or device enabling storage and/or planting of seeds, bulbs or tubers.

In particular, the device shall enable an easy and/or cheap long-term storage of a planting container and/or an easy and undemanding transportability.

Further, the planting container should be suitable for planting in areas difficult to access and independent of the hardness of the ground in such areas.

In particular, the growing plant should be protected from strong winds, and preferably from too intensive sunlight.

In particular, the plant should also be protected from hazardous substances in polluted areas for a determinable time.

Another object of the invention can consist in overcoming at least one of the above mentioned disadvantages.

### SUMMARY

The above mentioned technical problem is solved by the subject matter of appended claim 1 which is directed to a (closed/autarkic/self-sufficient) container (or box/receptacle) for storing and planting seeds, bulbs, or tubers. The container comprises a housing made of a non-water soluble material, the housing comprising a first compartment for receiving at least one seed, bulb or tuber, the first compartment being essentially free of water (and, in various embodiments, also free of nutrients), and a second compartment for receiving nutrients promoting growth of the seed, bulb or tuber, the second compartment being arranged below the first compartment. In accordance with the present invention the first and the second compartments are separated by a separation layer. In various embodiments the housing has a rounded (in particular an essentially half-spherical) shape at its bottom, and the container has a center of gravity arranged such that the container is adapted to erect itself (to stand automatically upright) when it is deposited on a supporting surface in a tilted manner.

The container according to the present invention provides several advantages for storing and plant growth:

For example, providing a non-water soluble housing ensures that the plant can germinate or start growing without contact to the environment. This might for example be of advantage in polluted areas in which the plant needs to reach a certain critical size in order to be viable under such negative conditions.

Further, the container can even be used in areas with a very hard, dry, frozen or already enrooted ground in which it is difficult or nearly impossible to entrench a plant. Also this feature helps to avoid a premature contact of the seed or plant with the environment. At the same time an automatic upright standing ensures optimal conditions for the plant's growth. In particular, this feature is of advantage in case of an aerial or air-borne drop. The shape of the housing could for example be essentially spherical. However, other shapes are also within the scope of the present invention as for example essentially half-spherical, ellipsoidal or drop-like shapes.

It is remarked that the container is not intended to be used with or to comprise a seedling, i.e. a small plant germinated already. Such a seedling usually needs water, sunlight and/or sufficient temperatures to stay alive. Such aspects would result in heavy restrictions and high costs with respect to long-term storage. According to the present invention, the seed, bulb or tuber is separated from any water when lying in the first compartment. Since the upper and the lower compartments are separated from each other by the separation layer and the upper compartment does not contain water, a long-term storage of the system can be possible.

Further, it is assured that the second compartment is below the first compartment after deposition so that the seed, tuber or bulb is positioned above the nutrients. The capability of a self-orientation of the container can also be crucial for other aspects of the invention described below.

The present invention can also be directed to a container for storing and planting seeds, bulbs or tubers, wherein the container comprises a housing made of a non-water soluble material, the housing comprising a first compartment for receiving at least one seed, bulb or tuber, the first compartment being essentially free of water (and, in various embodiments, also free of nutrients), and a second compartment for receiving nutrients promoting growth of the seed, bulb or tuber, the second compartment being arranged below the first compartment, wherein the first and the second compartments are separated by a separation layer and wherein the container comprises (activation) means or an activation system for destruction of the separation layer.

According to an aspect of the present invention, the second compartment comprises a (firm or viscous) nutrient matrix, for example a gel for storing water. Such a nutrient matrix allows long-term storage of the container and can comprise any nutrition the plant will need for a certain time of growth. The composition of the nutrient matrix can for example be a plant nutrient solution stabilized in a gelling agent like agar, pectin, glutamate, or any other solidifier. Of course such nutrition can be adapted by the person skilled in the art to the used sort of plant. Thus, the container can be even deposited in barren areas, wherein especially at the beginning of the plant's growth, the plant is very sensitive to sufficient water supply and appropriate nutrition. After some time of growth the plant can be strong or tall enough to grow further on the basis of the soil surrounding the deposited container. In general, nutrients can be already present in the container during storage or could be added later by a customer. For example, the housing could include a screw closure for opening the container between the separation layer and the bottom of the container so that nutrients could be applied to the second compartment by a customer. In general, one nutrient composition could be used for several seeds. Another possible advantage consists in that the nutrient composition can e.g. be chosen for a seed on a short term according to current environmental conditions. Moreover, the geometry could be selected on a short term according to the landscape where it will be used. Alternatively or in addition, the housing could comprise any other kind of closure or gate allowing introduction of nutrients into the lower compartment. Alternatively or in addition, the same could apply to placement of a seed, bulb, tuber or seedling. In particular, the housing or the first compartment can comprise a screw closure for placing a seed, tuber, bulb or seedling into the first compartment. Alternatively or in addition, the first compartment can comprise any other kind of closure or gate allowing introduction of a seed, bulb or tuber. Screw closures might for example be circumferential with the housing (e.g., essentially parallel to the plane of the separation layer). Alternatively a screw closure might be provided in the form of screw cap allowing access to one or both of the compartments. As another alternative, one or both of the compartments could be provided with a watertight plug, which can be opened to equip the respective compartments with a seed, bulb, tuber or nutrients, respectively.

According to another aspect of the invention the housing comprises biodegradable materials or portions with reduced wall thickness or combinations thereof. Thus, after a desired time the housing can degrade so that the plant can get into contact with the environment and the ground surrounding the device. Thus, roots start to enroot into the surface of soil beside or below the device. Further, the wall thickness and/or the material of the housing can be designed such that the plant can penetrate the housing after a certain time of growth within the container.

Thus, according to another aspect of the invention the housing is penetrable by roots or is destroyable by roots originating from the seed, bulb or tuber. In various embodiments, the housing comprises one or more of the following materials: paper, carton, plastic, rubber, ceramics, glass, pottery, layer of salt, sheets of metal, textiles or braids of such materials. The thickness and exact material can be chosen by the person skilled in the art and can depend on the plant to be planted.

According to yet another aspect of the invention, the container comprises (activation) means for destruction of the separation layer. For example, such means could comprise means for mechanically penetrating and/or breaking the separation layer, as e.g. a needle or object for penetrating the separation layer adapted to be manually pressed from outside of the container through the separation layer. As another example, the housing might comprise at least one flexible portion adjacent the separation layer so that the separation layer can be destroyed by pressing the flexible portion. Such manual means for destructing the separation layer or in other words for activating the container or trigger germination or growth of a seed, tuber or bulb can be easily and quickly handled for a large number of devices without any need of specially trained or educated personnel. In particular, if the housing is made of one of paper, carton, plastic, sheets of metal it can be adapted to be flexible for destruction of the separation layer by exerting a manual force on the housing.

Other means for activation could comprise a chemical dissolution of the separation layer. For example, the separation lay could be partially made of water soluble-salts. The container could comprise a pocket of water destructible by mechanical pressure. Thus, such a pocket could be destroyed by mechanical means as mentioned above or for example by pressure on a flexible portion of the device's housing. Of course the described dissolution is not limited to the application of water-soluble salts. Other combinations of chemicals could be used as well.

As another example, the separation layer is made of a material melting or degrading above a defined temperature. Such a temperature could be for example between 20° C. and 50° C., e.g., between 25° C. and 45° C. Thus, the separation layer could comprise or be made of a wax which melts after the container has been heated by sunlight. However, the separation layer can be essentially water-free.

According to still another aspect of the invention, the separation layer is a brittle plate, grid, braid or a film, e.g. made of salts, ceramics, glass, plastics, etc. The separation layer could also be a sheet of paper or card board. In particular, the separation layer has a planar shape extending essential in a horizontal direction. Alternatively or in addition the separation layer can comprise a depression for receiving the seed, bulb or tuber. Such a depression could be arranged at or near the center of the compartment so that the seed, bulb or tuber has better starting condition for growth. In particular, this feature can promote uniform growth and enrooting of the plant in the nutrients of the lower compartment.

According to yet another aspect of the invention, the housing is watertight with respect to the environment of the container at least in the portion of the second compartment. Alternatively, the housing is (completely) watertight with respect to the environment of the device. This feature improves the separation between the inner volume of the housing and the environment of the device. Thus, on the one hand, premature germination or growth during storage of the container is excluded and on the other hand, an early contact of the plant with the surrounding environment after deposition of the container to a planting location is avoided. In various embodiments, the housing is opaque.

According to yet another aspect of the invention, the housing has at least one aperture in a top area of the container, the aperture being covered by a cover layer (/film or foil). Such a cover layer could be either opaque or transparent depending on the specific application or plant to be planted.

In various embodiments, the cover layer comprises an at least partially transparent foil or film for enabling a greenhouse effect within the housing. Thus, the plant can enjoy a greenhouse effect similar as under the conditions in a greenhouse or a plant production facility.

In various embodiments, the cover foil is penetrable for a plant originating from the seed, bulb, tuber or seedling. In other words, the growing plant can pierce or break the cover foil during growth. Then rain can fall through such an opening into the device. Thus, the young plant will be supplied by additional water but can be still without contact to soil surrounding the container.

According to another aspect of the present invention, the first compartment comprises an additional cover layer (/foil or film) arranged between a cover layer covering the aperture and the separation layer. Thus, the separation layer can comprise a transparent foil and the additional cover foil might be for instance an opaque layer. Alternatively, the cover foil covering the aperture is opaque and the cover foil between the latter and the separation layer comprises a transparent foil. An opaque layer can be of desire in case of a plant which shall germinate in darkness. The additional cover foil allows for a greenhouse effect.

In general, the application of the above mentioned foils or films constitutes an easy and cheap manner of providing containers with considerable abilities.

According to another aspect of the invention, at least one of the cover layers (or both) comprises a slit or hole for introducing a seed, tuber, bulb into the first compartment. Thus, the container could for example be sold or sent to customers without a seed, tuber or bulb and be self-equipped or filled by the customer. Alternatively, the first compartment can comprise a seed, bulb, tuber or seedling by default.

According to still another aspect of the invention the separation layer comprises nutrition, for example in the form of an inorganic salt as for example Hydroxyapatite, Ca3(PO4)2, KCl, CaNaPO4*CaSiO4, (NH4)2HPO4. Thus, the present container offers a further possibility of providing further substances for promoting the plant's growth inside the device.

The present invention is also directed to a method of using the above mentioned device. In particular, the container according to the present invention can be stored in a first step and can be activated in a subsequent step by destruction of the separation layer such that the seed, bulb or tuber gets into contact with the nutrient matrix in the lower compartment. Afterwards, the container is deposited onto a surface. The surface could for example be an area of land or soil. Alternatively, it could be a water surface or also the ground of a lake, a pond or the sea.

All features of the above described aspects can be combined or replaced with one another.

### DRAWINGS

In the following, we briefly describe the figures according to embodiments of the present invention. Further details are given in the detailed description of the embodiments. The figures have the purpose of illustrating the invention and should not be understood in a limiting sense.

FIG. 1 depicts a schematic perspective view of a container, according to various embodiments of the present invention;

FIG. 2 depicts a schematic perspective view of the container according to various embodiments of the present invention, wherein the container comprises separation walls extending essentially perpendicular to the separation layer;

FIG. 3 depicts a schematic perspective view of the container according to various embodiments of the present invention, comprising mechanical activation means for destruction of the separation layer;

FIG. 4 depicts a schematic perspective view of the container according to various embodiments of the present invention comprising a further cover layer above the separation layer; and

FIG. 5 depicts a schematic perspective view of the container according to various embodiments of the present invention.

### DETAILED DESCRIPTION

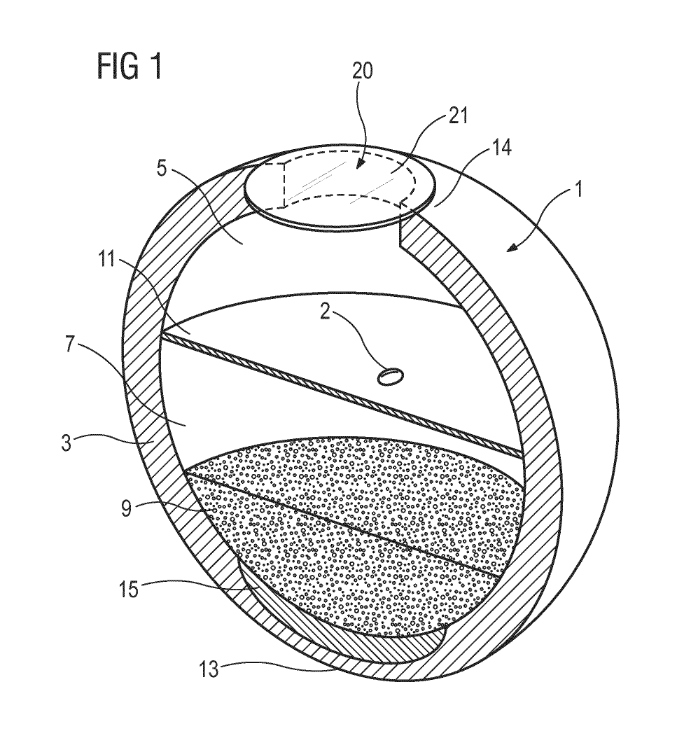

FIG. 1 depicts one exemplary embodiment of a container 1 according to the present invention. The container comprises a housing 3 depicted with an essentially spherical shape. The housing 3 is divided into a first 5 and a second 7 compartment by a separation layer 11. In various embodiments, the separation layer 11 has a planar shape and can extend essentially in a horizontal direction. The first compartment 5 can comprise a seed 2, wherein for the sake of conciseness, the word seed 2 is used in the following as a synonym to a bulb 2 or a tuber 2. The second compartment 7 is arranged below the first compartment 5 or in other words below the upper compartment 5. The lower compartment 7 can receive or comprise nutrients 9. Such nutrients can be provided in the form of a nutrient matrix or in the form of a gel. In various embodiments, the lower compartment 7 comprises also water. Water can be bound in a matrix or a gel. In various embodiments, the container 1 (or the housing 3) comprises a mass or a weight 15. Such a mass 15 could e.g. be made of metal, stone, ceramics, etc. It could have different shapes not restricted to the depicted plate-like form. More compact shapes as e.g. spherical or cubic shapes could be used as well. However, it is not necessary to use a separate mass 15 as depicted in FIG. 1. It is also possible to design the housing 3 as such with an appropriate mass distribution so that together with the rounded shape of the housing's 3 bottom 13, the container 1 can be adapted to stand automatically upright. The exact design can also depend on the type, size and number of seeds 2 to be planted with the container 1 as well as on the amount of nutrition and the size of the housing 3. These parameters can be chosen by the person skilled in the art depending on the desired application of the container 1. The container 1 has been depicted with an essentially spherical housing 3. However, other shapes are also possible, as for example half-spherical, drop-like, or ellipsoid shapes.

As also depicted in FIG. 1, the housing can comprise an upper aperture or window 20 which can be covered by a layer or foil 21. In particular, an at least partially transparent foil 21 results in the effect that a greenhouse effect can be provided within the housing 3 for promoting germination of the seed 2 or growth of a respective plant. Alternatively, the foil 21 can be essentially opaque so that a seed 2 can germinate in darkness. The foil 21 can have a planar shape and can extend essentially in a horizontal direction. Of course, the foil 21 or the aperture 20 do not need to have a circular shape other shapes can also be possible. The foil 21 could for example be made of plastics or paper material. The same applies to the housing 3. However, in general the housing is made of a non-water soluble material in order to assure that the seed 2 can germinate or grow for a desired time without getting into contact with the environment outside the housing 1. In various embodiments, the housing material is biodegradable. In addition, the housing 3 can be penetrable by the roots of the plant resulting from the seed 2, so that the plant can enroot in the environment of the container 1.

The container 1 can have any desired dimensions. For example, in various embodiments, the container 1 can have a shape with a maximum dimension or diameter smaller than 30 cm, e.g., smaller than 20 cm, or smaller than 10 cm. The container 1 is free of any supply lines. In particular it does not need or have any external electrical current lines or water supply lines. Further, the container 1 does not have to be stored under specific conditions. In particular, freezing of the container 1 is not required for storage purposes. It is storable at room temperature. Consequently, the storage and use of the container 1 is simple and cheap and does not require costly infrastructure and equipment.

In various embodiments, the container 1 can be activated or triggered to start germination of the seed 2. In various embodiments, such activation can be provided via a destruction of the separation layer 11, as e.g. by dissolution, piercing, breaking, etc. For example, the separation layer 11 could be made of a brittle material which breaks upon pressure (mechanical shock) on an adjacent (outer) area of the housing 3. For this purpose the housing could be at least partially deformable adjacent to the separation layer 11. If, for example, the housing is made of paper, plastics, or carton (card board) such deformability is provided. By applying a pressure to the housing, the separation layer 11 can be broken so that the seed 2 gets into contact with the ingredients of the lower compartment 7. In particular, the contact with water stored or bound in the lower compartment 7 can trigger the germination of the seed 2.

Before activation, the upper compartment 5 is essentially free of water in order to avoid a premature germination or growth during storage of the container 1. In various embodiments, the upper compartment is also free of nutrients and/or any soil.

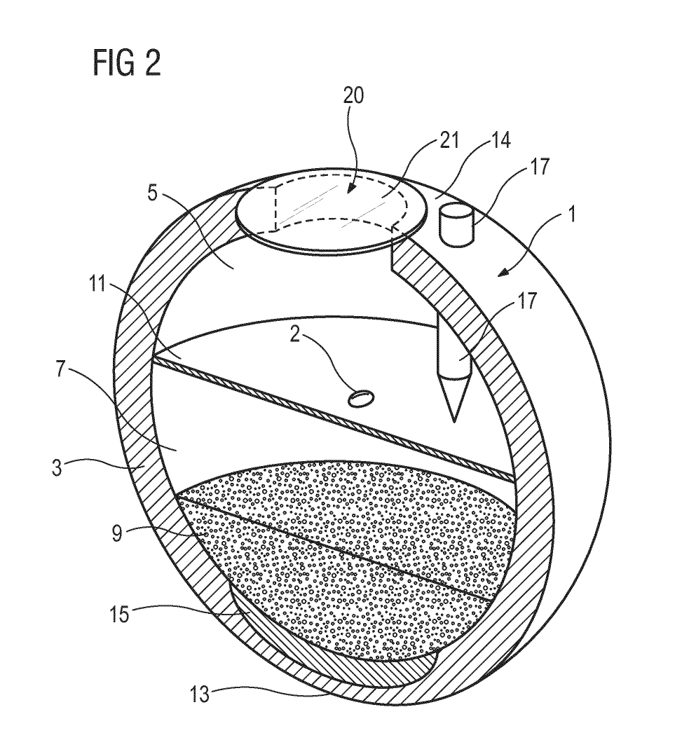

According to FIG. 2, the container 1 is equipped with another kind of mechanical activation means 17 for destruction of the separation layer 11. For example, as exemplarily depicted the container can comprise a pin or a needle 17 for piercing or breaking the separation layer 11. Breaking the separation layer 11 allows a contact of the seed 2 with the nutrients and water stored in the lower compartment 7.

Alternatively, the activation means 17, e.g., the pin or needle, can pierce a pocket of water or chemicals for dissolving the separation layer 11 (not shown). According to another alternative, the activation means 17 can comprise an injection nozzle or syringe for introducing from outside the housing 3 water or chemicals into the housing 3 to dissolve the separation layer 11.

In various embodiments, the activation means 17 for destruction of the separation layer 11 can be integrated in the container 1 such that activation of the container 1 does not require any supply lines (as e.g. electrical current). The application of manual force can be sufficient.

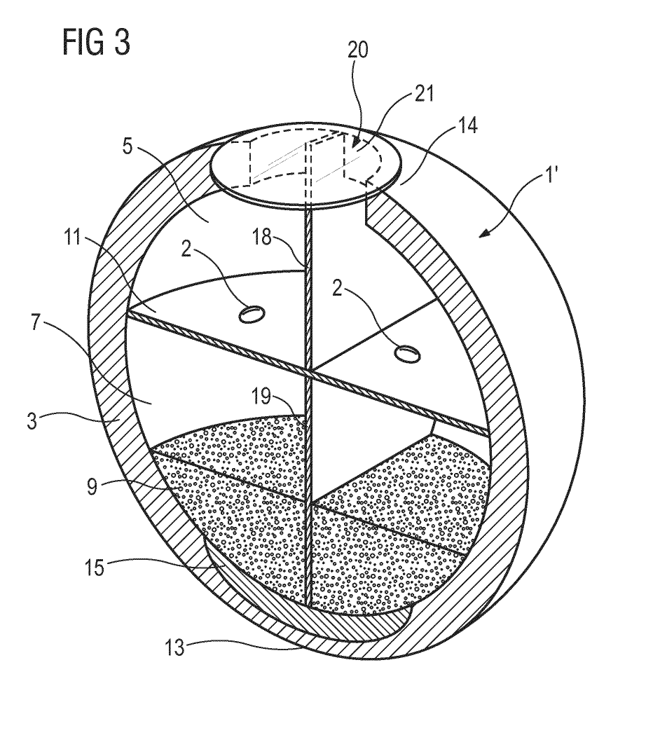

FIG. 3 shows another exemplary embodiment of a container 1′ in accordance with various embodiments of the present invention. In particular, in various embodiments, the container 1 can comprise two seeds 2 within separate chambers of the first compartment 5 divided by an essentially vertically extending separation wall 18. In various embodiments, each chamber of the first compartment 5 comprises one seed 2. As depicted, it is possible that the second compartment 7 is also divided by a second essentially vertically extending separation wall 19. Thus, each seed 2 can be provided with an own chamber in the first compartment 5 and with a corresponding chamber in the second compartment 7. The respective nutrition and water supply in the corresponding chamber of the second compartment 7 can be adapted to the requirements of the specific seed 2. The material of the separation wall can be non-biodegradable and/or not penetrable by the plant's roots in order to minimize competition between the plants growing the separate chambers. In particular, different kinds of seeds, bulbs or tubers 2 can be provided in one container 1′. Each of the seeds can be provided with appropriate nutrients and water supply. The size of each chamber can be adapted to the specific size and sort of the seed, bulb, or tuber 2. As exemplarily depicted, a common wall 18, 19 can run through both compartments 5, 7. The walls 18, 19 have been depicted as being essentially perpendicular to the separation layer 11. However, the walls can extend also in other directions. In various embodiments, the wall 18 of the first compartment 5 extends from the separation layer 11 to a portion of the cover foil 21 such that this foil 21 can be pierced by a plant growing in its chamber and/or such that light can still fall through a transparent cover foil 21 into each chamber of the first compartment 5.

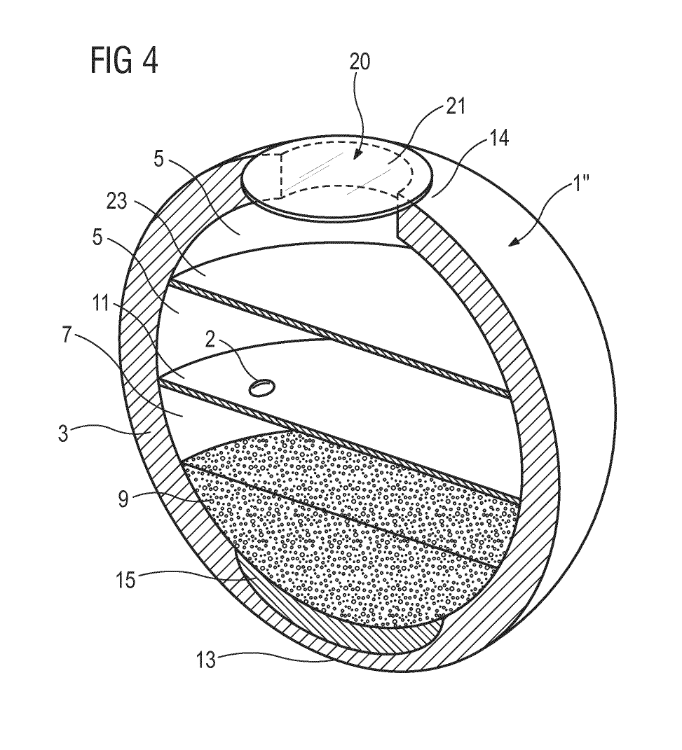

FIG. 4 depicts a further container 1″ in accordance with various other embodiments of the present invention. In contrast to the container 1 as depicted in FIG. 1, the container 1″ comprises a second cover foil 23 arranged between a cover foil 21 covering the hole in a top portion 14 of the housing 3 and the separation layer 11. For example, the additional foil 23 could be essentially opaque or black and the cover foil 21 could be transparent. Such an arrangement allows generation of a greenhouse effect between the cover foil 21 and the additional cover foil 23. The heat will also be conducted to the remainder of the container 1″. This can be of advantage for seeds 2 which germinate in darkness. After a certain time of growth plants 2 resulting from such seeds 2 can break the opaque cover layer 23 so that they can receive light shining through the transparent window 21. In various embodiments, that transparent cover foil 21 can also be broken by the further growing plant 2.

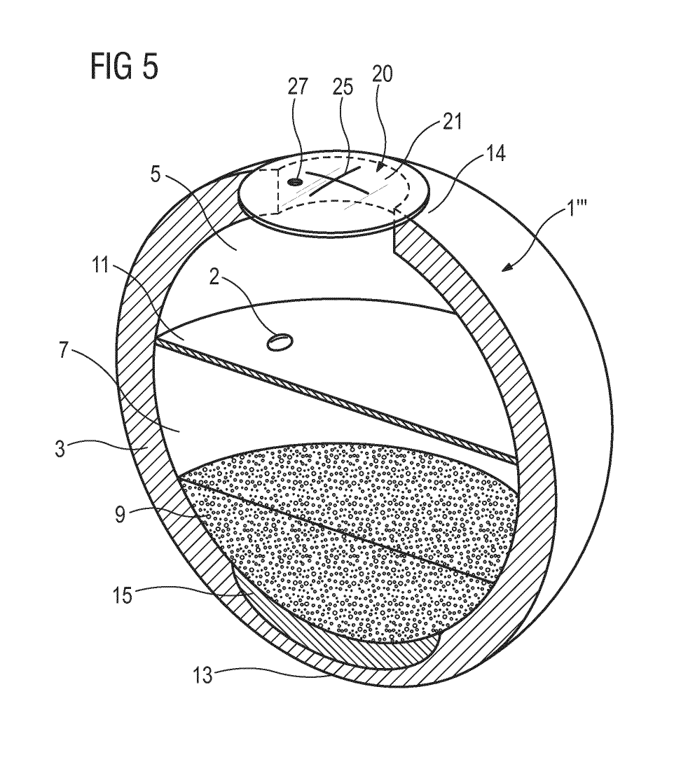

FIG. 5 depicts another embodiment of a container 1′″ according to various other embodiments of the present invention. In contrast to the container 1 depicted in FIG. 1, the cover foil 21 covering the aperture 20 in the top portion of the housing 3 comprises slits 25 and apertures 27. Slits 25 and/or apertures 27 can be used for introducing or placing a desired seed 2 into the upper compartment 5. In addition, or alternatively, such slits 25 or apertures 27 can be used to provide access for an activation means 17 (either mechanical or chemical) for destructing the separation layer 11. Slits 25 or apertures 27 can e.g. be cut by a knife. Alternatively, or in addition, slits 25 and/or apertures 27 can be present in the housing 27 so that seeds 2, tools or nutrients 9 can be introduced from outside the container into one of the compartments 5, 7.

The invention has been described with reference to best modes of carrying out the invention. Obviously, modifications and alterations will occur to others upon a reading and understanding of this specification. It is intended to include all such modifications and alterations in so far as they come within the scope of the appended claims or the equivalents thereof.

In any case the above described embodiments shall not be understood in a limiting sense. In particular, the features of the above embodiments can also be replaced or combined with one another.

### LIST OF REFERENCE SIGNS

1 container/planting box
1′ container/planting box
1″ container/planting box
1′″ container/planting box
2 seed/bulb/tuber
3 housing/body housing
5 first compartment/upper compartment
7 second compartment/lower compartment
9 nutrients/nutrient matrix/gel
11 separation layer
13 bottom portion of the container/housing
14 top portion of the container/housing
15 weight
17 activation means for destruction of separation layer
18 separation wall
19 separation wall
20 aperture
21 cover layer/foil
22 separation wall/foil
23 additional cover layer/foil
25 slit
27 hole

1-15. (canceled)

16. A container for storing and planting seeds, bulbs or tubers, the container comprising:
a housing made of non-water soluble material, the housing comprising:
a first compartment for receiving at least one of a seed, a bulb and a tuber, the first compartment being essentially free of water;
a second compartment for receiving nutrients enabling growth of the at least one seed, bulb and tuber, the second compartment being arranged below the first compartment, and
a bottom portion; and
a separation layer separating the first and the second compartments, and wherein the bottom portion of the housing has a rounded shape and the container has a center of gravity arranged such that the container is adapted to erect itself when it is deposited on a supporting surface in a tilted manner.

17. The container according to claim 16, wherein the second compartment comprises a nutrient matrix comprising water, the water being bound in the nutrient matrix.

18. The container according to claim 16, wherein the nutrient matrix is a gel for storing water.

19. The container according to claim 17, wherein the housing consists of non-water soluble, biodegradable materials.

20. The container according to claim 19, wherein the housing has portions with a reduced wall thickness.

21. The container according to claim 19, wherein the housing is penetrable by roots originating from the at least one seed, bulb and tuber, and wherein the housing comprises at least one of paper, carton, plastics, sheets of metal and braids of materials.

22. The container according to claim 21, wherein the container comprises an activation means for destruction of the separation layer.

23. The container according to claim 22, wherein the activation means comprises one of:
a means for one of mechanically penetrating and breaking the separation layer, and
a means for chemically dissolving the separation layer.

24. The container according to claim 23, where the separation layer is made of a water-free material that melts above a defined temperature.

25. The container according to claim 23, wherein the separation layer comprises one of a brittle plate, grid, braid and film.

26. The container according to claim 25, wherein one of:
the housing is watertight with respect to the environment of the container in a portion of the second compartment, and
the housing is watertight with respect to the environment surrounding the container.

27. The container according to claim 26, wherein the housing has at least one aperture in a top area of the housing, the aperture being covered by a water-tight cover layer.

28. The container according to claim 27, wherein the cover layer comprises an at least partially transparent foil for enabling a greenhouse effect within the housing, the cover layer being penetrable for a plant originating from the at least one seed, bulb and tuber.

29. The container according to claim 28, wherein the first compartment comprises an additional cover layer arranged between the cover layer covering the aperture and the separation layer such that a first space is provided between the additional cover layer and the separation layer and a second space is provided between the additional cover layer and the cover layer covering the aperture.

30. The container according to claim 29, wherein at least one of the cover layers is essentially opaque.

31. The container according to one of claim 30, wherein one of:
one of at least one of the cover layers, and the housing comprises one of a slit and a hole for introducing the at least one seed, bulb and tuber into the first compartment, and
the first compartment comprises the at least one seed, bulb and tuber.

32. The container according to claim 31, wherein the separation layer comprises nutrition for the at least one seed, bulb and tuber.

33. The container according to claim 32, wherein the nutrition comprises an inorganic salt.

34. The container according to claim 32, wherein the inorganic salt comprises one of Hydroxyapatite, Ca3(PO4)2, and KCl.

35. A method of using a container for storing and planting seeds, bulbs or tubers, wherein the container comprises:
a housing made of non-water soluble material, the housing comprising:
a first compartment for receiving at least one of a seed, a bulb and a tuber, the first compartment being essentially free of water;
a second compartment for receiving nutrients enabling growth of the at least one seed, bulb and tuber, the second compartment being arranged below the first compartment, and a bottom portion; and
a separation layer separating the first and the second compartments, and wherein the bottom portion of the housing has a rounded shape and the container has a center of gravity arranged such that the container is adapted to erect itself when it is deposited on a supporting surface in a tilted manner;
said method comprises the sequential steps of:
storing the container;
activating the container by destructing the separation layer; and
depositing the container on a surface envisaged for planting the seed, bulb or tuber.
